(19) United States
(12) Patent Application Publication
(10) Pub. No.: US 2015/0009921 A1
(43) Pub. Date: Jan. 8, 2015

(54) METHOD FOR SCHEDULING AND MU-MIMO TRANSMISSION OVER OFDM VIA INTERFERENCE ALIGNMENT BASED ON USER MULTIPATH INTENSITY PROFILE INFORMATION

(71) Applicant: DOCOMO INNOVATIONS, INC, Palo Alto, CA (US)

(72) Inventor: Haralabos C. Papadopoulos, San Jose, CA (US)

(21) Appl. No.: 14/358,991

(22) PCT Filed: Nov. 15, 2012
(86) PCT No.: PCT/US2012/065344

§ 371 Date: May 16, 2014

Related U.S. Application Data
(60) Provisional application No. 61/561,205, filed on Nov. 17, 2011.

(51) Int. Cl. H04L 5/00; H04B 7/04

(52) U.S. Cl. CPC H04L 5/0037; H04B 7/0452; H04L 5/006
USPC 370/329

(57) ABSTRACT

A method and apparatus is disclosed herein for scheduling over ODFM via interference alignment based on multipath intensity profile information. In one embodiment, the method comprises grouping user terminals into groups based on their multipath intensity profiles, where at least one of the groups has two or more terminals; scheduling user terminal groups for MU-MIMO transmission; allocating OFDM resources to the user terminal groups for MIMO transmission; assigning MU-MIMO transmission codes to the user terminal groups; and performing MU-MIMO transmission of the user terminal groups using assigned MU-MIMO transmission codes.

### PRIORITY

The present patent application claims priority to and incorporates by reference the corresponding provisional patent application Ser. No. 61/561,205, titled, “A Method for Scheduling and MU-MIMO Transmission over OFDM via Interference Alignment based on User Multipath Intensity Profile Information” filed on Nov. 17, 2011.

### FIELD OF THE INVENTION

Embodiment of the present invention relate to the field of multi-user Multiple Output Multiple Input (MIMO) wireless transmission systems.

### BACKGROUND OF THE INVENTION

Many recent advances in wireless transmission have rested on the use of multiple antennas for transmission and reception. Multiple antennas, fundamentally, can provide an increase in the numbers of Degrees of Freedom (DoF) that can be exploited by a wireless system for transmission, i.e., the number of scalar data streams that can be simultaneously transmitted to the receiving parties in the system. Here, DoF can be used to provide increased spectral efficiency (throughput) and/or added diversity (robustness). Indeed, a Single User MIMO (SU-MIMO) system with N_{T} transmission (TX) antennas serving a single user with NR receive (RX) antennas may be able to exploit up to min(N_{T}, N_{R}) DoF for downlink transmission. These DoF, for example, can (under certain conditions) be used to improve throughput by a factor that grows linearly with min(N_{T}, N_{R}). Such benefits of MIMO, and increased DoF, underlie much of the interest in using MIMO in new and future systems.

Exploiting such DoF often requires some amount of cost to the system. One such cost is knowledge of the channel state between transmitting and receiving antennas. Such Channel State Information (CSI) often has to be available to either the transmitter (such CSI is termed CSIT) and/or to the receiver (such CSI is termed CSIR). The DoF available also depend on having sufficient “richness” in the channels between transmitting and receiving antennas.

For example, SU-MIMO CSIR-based systems such as Bit Interleaved Coded Modulation (BICM) and D-BLAST can achieve the maximum possible DoF of min(N_{T}, N_{R}) under suitable channel conditions. Such SU-MIMO systems do not require CSIT (i.e., CSIT does not improve the DoF, although CSIT can still enable improvements in spectral efficiency in some scenarios). Under such conditions, these SU-MIMO designs therefore can be used to provide corresponding linear increases in spectral efficiency. Such designs are well understood by those familiar with the state of the art.

Similarly, a Multi-User MIMO (MU-MIMO) system with N_{T} transmission antennas at the base station (BS) and K single-antenna user terminals (or devices) (N_{R}=1) can provide up to min(N_{T}, K) DoF. As in the case of SU-MIMO, MU-MIMO can, for example, be used to improve throughput linearly with min(N_{T}, K).

However, unlike SU-MIMO, many MU-MIMO techniques (in fact most if not all of the prevailing MU-MIMO techniques used and studied for standards) require knowledge of CSIT. Much like SU-MIMO based on CSIR, MU-MIMO, requires the allocation of resources for training pilots, in order to obtain CSIR, i.e., in order to estimate at each receiver the channel between the transmit antennas and the receiver's receive antennas. Unlike SU-MIMO based on CSIR, MU-MIMO based on CSIT requires additional overheads to feedback the receiver's CSI to the transmitter before the transmission can take place.

Despite such overheads, MU-MIMO is of practical interest since it has the benefit over SU-MIMO of being able to grow the DoF without having to add many receive antennas, radio frequency (RF) chains, or increase processing (e.g., decoding) complexity to portable or mobile terminals.

The issue of CSI overhead has to be considered carefully. It is a fundamental issue often overlooked in assessing such conventional MIMO. Such CSI-related overhead in fact can represent a fundamental “dimensionality bottleneck” that can limit the net spectral efficiency increase that can be obtained with conventional CSI-dependent MIMO.

In particular, if one wants to continue to exploit the growth in DoF (e.g., linear growth) by increasing N_{T} (or N_{R} or K), one also has to consider how to support increased system overhead in obtaining the CSI required to formulate transmissions and to decode at the receivers. Such overhead can include increased use of the wireless medium for pilots supporting CSI estimation and increased feedback between receiving and transmitting entities on such CSI estimates.

As an example, assume that for each complex scalar value that defines the CSI between a single TX antenna and a single RX antenna (this type of CSI is often termed direct CSI by some in the Standards community) a fixed percentage, F of wireless-channel resources is dedicated to pilots and/or feedback. One can easily see that as the dimension of the CSI required scales with quantities like N_{T}, N_{R} and/or K, the total CSI system-related overhead grows (e.g., by N_{T}×F_{csi}). For example, for K single antenna user terminals, each with N_{T} CSI scalar terms with respect to the transmitting antenna, there are a total of KN_{T} such complex scalar values that the transmitter may need to know. Supporting an increase in the dimension of the CSI can take more wireless-channel resources and can reduce the amount of resources left for data transmission. This overhead increase can limit continued growth in throughput if spectral efficiency improvements do not offset increased CSI overheads.

The value F_{csi} is often defined either by the system or by necessity given the coherence of channels in time and/or frequency. As the state of channels changes more rapidly in time and/or frequency, a larger effective fraction of resources may need to be used to estimate and keep track of CSI.

As an example, in a Frequency Division Duplex (FDD) based 3GPP Long Term Evolution (LTE) design, 8 symbols in a resource block of 12×14 OFDM symbols are used to support downlink pilots for each of the N_{T} antennas. Simply considering system overhead for such pilots, and ignoring other CSI related overhead such as feedback, F_{csi} can be as large as 8/168=4.76%. In such a case, with N_{T}=8, assuming the pilot structure scales linearly with additional antennas, the total CSI-overhead could be as large as 38%, leaving 62% of symbols for supporting the remaining signaling overheads and data transmission. In fact, for LTE, there are proposals being considered to change the pilot structure beyond N_{T}=4 antennas. However, this also has implications with regard to CSI accuracy. Nonetheless, clearly, such a system would not support unbounded increases in N_{T}.

Thus, though symbols that represent coded data information are used more efficiently, with increased robustness and/or spectral efficiency due to the increased DoF by MIMO, the net spectral efficiency increases have to account for the fraction of resources used for CSI overhead. Thus, the net spectral efficiency growth is in fact less than that of individual data symbols as only a fraction, e.g. no more than (1N_{T}×F_{csi}), of symbols can be used for data.

Recently, a new class of techniques, termed “Blind Interference Alignment” (BIA) techniques, has demonstrated the ability to grow DoF without requiring many of the CSI overheads of conventional MU-MIMO systems. It is possible for a BIA Multi-User MIMO (MU-MIMO) system with N_{T} transmission antennas at the BS and K single active-antenna users to achieve KN_{T}/(K+N_{T}−1) DoF without CSIT. Thus, as K grows, the system can approach the CSI-dependent upperbound of min(N_{T},K) DoF that is achievable by conventional MU-MIMO CSIT-based systems. This is a striking result since it goes beyond conventional thinking and most conjectures made over recent decades, and it provides the potential to relieve the “dimensionality bottleneck” being faced by current systems.

For such a system to work, there is a requirement that the channels between the transmitting BS and the K user terminals being served must be jointly changing in a predetermined way (with respect to the blind interference alignment scheme). This joint variation can be accomplished by having multiple antenna modes, as discussed in Chenwei Wang, et al, “Aiming Perfectly in the Dark Blind Interference Alignment through Staggered Antenna Switching,” February 2010. This can be implemented by employing many (physical) antenna elements at each user terminal, or by having a single antenna element that can change its physical characteristic (e.g., orientation, sensitivity pattern, etc.). However, in all such cases, the system requires only that one mode be active at a given time slot. Thus, it is sufficient to have only a single RF chain at each user terminal, whereby the single active-receive antenna mode of a user terminal (i.e., the antenna driving the single RF chain of the user), can be varied over time. That is, the single active receive antenna is a multi-mode antenna able to switch between, (e.g., NT modes in a pre-determined fashion). Having a single RF chain keeps decoding complexity in line with conventional single-antenna mode MU-MIMO systems.

The modes must be able to create linearly independent CSI vectors for the single user. Transmission also has to be confined to a suitable coherence interval in time over which the CSI in a given mode, though unknown to the system, is assumed to be effectively constant and different from mode to mode.

The BIA scheme works by creating suitable antenna mode switching and combined data transmission vector over the K information bearing streams that are to be sent to the K user terminals (one stream carries the intended information for one user terminal). Such information bearing stream themselves are vectors. These are sent in various arithmetic combinations simultaneously, thereby using the extra DoF provided by the antenna mode switching.

The coordination of user receive-antenna switching modes and the way the information streams are sent by the BIA scheme is designed to maximize the DoF by complying with the following principles:
any N_{T} dimensional symbol intended for a given user terminal is transmitted over N_{T} slots.
during these N_{T} slots, the antenna-switching pattern of that user terminal ensures that the user terminal observes that symbol through all its N_{T} antenna modes (thereby in an N_{T} dimensional space) and can thus decode it.
in contrast, the antenna-switch patterns of the rest of the user terminals are such that the transmission of this N_{T} dimensional symbol only casts a 1-dimensional shadow to their receivers. This is accomplished by ensuring that each of these receivers uses the same antenna mode in all the N_{T} dimensional symbol is transmitted.

Thus, a total of (N_{T}+K−1) receiver dimensions are needed per user terminal to decode N_{T} scalar symbols. As a result, with this scheme, K user terminal decode a total of K N_{T} symbols (N_{T} each) per (N_{T}+K−1) channel uses, thereby achieving the maximum possible BIA DoF of K N_{T}/(N_{T}+K−1).

BIA techniques have some inherent challenges and limitations in the scenarios in which they can be used. First, although these BIA techniques can be readily implemented over OFDM, antenna-mode switching happens at best at the OFDM symbol rate (each user terminal keeps its mode constant within each OFDM symbol). As these schemes require the channels stay constant within the slots required to transmit a single codeword, they may require large coherence times in the user channels, i.e., they require the channels to remain constant sufficiently long to enable canceling out interference from other user terminals streams. Shorter coherence times than those required by the BIA scheme mean that some interfering streams won't be able to be canceled, resulting in a loss of DoF. More importantly, the original BIA schemes require the user terminals have the ability to switch between active antenna modes in order to enable channel/user differentiation for MU-MIMO transmission in the absence of CSI. Such a scheme can thus not be implemented on a terminal with a single conventional receive antenna.

### SUMMARY OF THE INVENTION

A method and apparatus is disclosed herein for scheduling over ODFM via interference alignment based on multipath intensity profile information. In one embodiment, the method comprises grouping user terminals into groups based on their multipath intensity profiles, where at least one of the groups has two or more terminals, scheduling user terminal groups for MU-MIMO transmission, allocating OFDM resources to the user terminal groups for MIMO transmission, assigning MU-MIMO transmission codes to the user terminal groups, and performing MU-MIMO transmission of the user terminal groups using assigned MU-MIMO transmission codes.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates processing and feedback of pertinent CSI from user terminal k.

FIG. 2 illustrates processing of pertinent CSI (from uplink feedback) from several user terminals, code-selection for each user terminal pair, and resource partitioning among user terminals and user terminal pairs for single and multi-user transmission.

FIG. 3 illustrates a three-user example, illustrating: a) the mapping of each user-MIP nonzero tap delays to ranks in their L-component polyphase decompositions for a set of L values (top table); b) the corresponding pairings of users into polyphase components (arrow sets emanating from each entry in the bottom table); and c) the DoF that can be achieved via the MU-MIMO IA codes using techniques described herein.

FIG. 4 illustrates an example of resource-block sets used by MU-MIMO implementations, which achieve the DoF in FIG. 3 for the user pair (1,2) using the pair of polyphase decompositions corresponding to L=2 and L=3 polyphase components.

FIG. 5 is a high-level flow diagram of the operation at the base station.

FIG. 6 shows a block diagram of a design of base station.

FIG. 7 is a block diagram of one embodiment of a scheduler.

FIG. 8 is a block diagram of one embodiment of a user terminal.

### DETAILED DESCRIPTION OF THE PRESENT INVENTION

Embodiments of the invention include a new scheduling and transmission scheme that exploits opportunistic interference alignment (IA) over OFDM to support Multi-User MIMO (MU-MIMO) transmission. In such a system, multiple user terminals, each having one (or a few) receive antenna element(s) are able to simultaneously receive user-specific data streams (at least one intended for each user) over the same transmission resource. Embodiments of the invention build upon a class of techniques known as Blind Interference Alignment (BIA) techniques that can be used to support MU-MIMO transmission. The BIA techniques allow transmission and alignment of interference between the streams to be done without the transmitter needing to know the instantaneous channel state information (CSI) between transmitter and receiver. BIA MU-MIMO schemes, however, require receivers with the ability to switch between several antenna modes.

The MU-MIMO schemes presented herein exploit knowledge of slowly-changing features of each user's channel at the base station (BS), to enable opportunistic MU-MIMO transmission using conventional antennas and without the need for mode-switching requirements at each user. That is, embodiments of the invention deal with the need for MU-MIMO schemes that enable high DoF without requirements of knowledge of fast-changing CSIT, or the need for coordinated antenna-mode switching. In particular, embodiments of the invention include a class of MU-MIMO schemes, which do not suffer from the high CSIT overheads of conventional MU-MIMO systems, and do not require the ability to switch between different antenna modes. Embodiments of the invention rely on features of the user channels that change slowly with time and in particular features of the user multipath intensity profile (MIP), in order to enable channel/user differentiation. Subject to slowly varying features of each user's multipath intensity profile, user terminals are opportunistically placed into groups for MU-MIMO transmission via suitably designed coding schemes appropriately mapped on subsets of the OFDM plane.

Embodiments of the invention include non-trivial extensions and generalizations of the perfect-alignment BIA codes that are employed for antenna switching, which broaden significantly the scope and the set of cases where opportunistic alignment can be exploited in practice for MU-MIMO transmission based on information on each user terminal's multipath intensity profile. Embodiments of the invention provide a systematic framework for identifying a broad class of interference alignment scenarios that can be exploited for MU-MIMO transmission; techniques for choosing the best option in terms of the provided multiplexing gains for each user set; techniques for allocating resource blocks over OFDM and implementing codes over these blocks that enable achieving the multiplexing gains associated with the selected option.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

Embodiments of the invention use opportunistic MU-MIMO scheduling and transmission schemes for use with cellular networks. The new MU-MIMO schemes exploit knowledge of certain features of the user's multipath intensity profiles (that need to be slowly tracked) to schedule groups of users into MU-MIMO transmission. This MU-MIMO transmission relies on new code designs that are non-trivial generalizations of the BIA MU-MIMO coding designs from Chenwei Wang, et al., “Aiming Perfectly in the Dark Blind Interference Alignment through Staggered Antenna Switching,” February 2010, appropriately mapped on the OFDM plane to enable the interference alignment required to achieve high DoF. The schemes proposed herein can also be used in conjunction with codes employing power-variations within the alignment structure as presented in U.S. patent application Ser. No. 13/223,762, entitled “A Method to Deploy Efficient Blind Interference Alignment Using a Combination of Power Allocation and Transmission Architecture,” filed on Sep. 1, 2011 and U.S. patent application Ser. No. 13/239,167, entitled “Method for Efficient MU-MIMO Transmission by Joint Assignments of Architecture and Interference Alignment Schemes using Optimized User-Code Assignments and Code Allocation,” filed on Sep. 21, 2011.

### Opportunistic MU-MIMO Schemes Enabled by the Invention

Embodiments of the invention use features of the users' multipath intensity profiles to form user groups for joint MU-MIMO transmission over OFDM. Consider a setting with a single N_{T}-antenna transmitter and many single-antenna receiver terminals. The effective discrete-time 1×N_{T} channel impulse response between the N_{T} transmit antennas and the single receive antenna of user k is denoted by the 1×N_{T} vector sequence h^{[k]}[n]. The proposed MU-MIMO schemes exploit polyphase decompositions (PD) of the user multipath-intensity profiles (MIPs). Let b^{[k]}[n] denote the effective discrete-time MIP of user k, and {e_{L,j}^{[k]}[n]}ⱼ₌₀^{L-1} denote its L polyphase components, i.e., e_{L,j}^{[k]}[n]=b^{[k]}[nL+j]. Also note that b^{[k]}[n]≧0 for all n and k. The channel response h^{[k]}[n] can be expressed as

h^{[k]}[n]=\sqrt{b^{[k]}[n]}\tilde{h}^{[k]}[n]

where E[|\tilde{h}^{[k]}[n]|²]=N_{T} and where E[•] denotes expectation. In practice, any subset of N vectors {\tilde{h}^{[k]}[nₘ]}ₘ₌₁^{N} are linearly independent when N≦N_{T} with probability 1. This condition is satisfied by many commonly used models, including discrete-time channel models with uncorrelated scattering. Note that, given an OFDM system with N tones, the channel response of user k at time t, H^{[k]}[f], is given by the N-point discrete Fourier Transform (DFT) of h^{[k]}[n].

The schemes presented herein are opportunistic in that they can enable MU-MIMO transmission via IA, provided the PDs of the user MIPs satisfy certain properties.

In describing them we shall make repeated use of the following definition:

Definition 1. The number of nonzero polyphase components in the L-component polyphase decomposition of the multipath intensity profile of a channel h[n] will be referred herein as the rank of the channel in its L-component polyphase decomposition.

Definition 1 is motivated by the next readily verifiable property:

Property 1. Assume that the 1×N_{T} channel vector h[n] has a rank-R polyphase decomposition in L components. Let H[f] denote the F-point DFT of h[n] with F=JL for some integer J. Consider a decimate-by-J (in frequency) version of H[f], i.e., consider the L×N_{T} matrix

H(lₒ)=[H^{T}[lₒ]H^{T}[J+lₒ]LH^{T}[(L−1)J+lₒ]]^{T} (1)

for a fixed but arbitrary lₒ ε{0,1,L, J−1}. Then Rank(H(lₒ))=min{R, N_{T}} with probability 1. Furthermore, any submatrix of dimension min{R, N_{T}}×N_{T} that is formed from any consecutive min{R, N_{T}} rows of H(lₒ) also has rank min{R, N_{T}} with probability 1.

As Property 1 suggests, the rank of the L-component PD of a channel specifies the rank of the matrix created by stacking together user's channels on OFDM tones spaced apart by one-Lth of the bandwidth. Note that the groups of tones comprising these channel matrices and the ranks of these matrices are both functions of the number of polyphase components, L. In one embodiment, MU-MIMO designs exploit these rank variations across pairs (or tuples) of users to schedule user terminals and design IA enabling codes that can provide DoF gains.

The following proposition describes the degrees of freedom achieved by the schemes associated with embodiments of the invention.

Proposition 1. Consider K 1×N_{T} channels, h^{[1]}[n], h^{[2]}[n], . . . , h^{[K]}[n]. Let Rⱼ^{[k]} denote the minimum of N_{T} and the rank of the PD of h^{[k]}[n] with Lⱼ polyphase components. Let H^{[k]}[f] denote the F-point DFT of h^{[k]}[n] with F=JΠₖ₌₁^{K}Lₖ for some integer J. Consider the set of tones

F(lₒ)={f;f=mJ+lₒ,m=0,1,L,Πₖ₌₁^{K}Lₖ−1} (2)

If the {Lₖ}'s are a relatively prime set, and Rₖ^{[k]}>max_{j≠k} Rₖ^{[j]}, for all k, MU-MIMO codes can be constructed on F (lₒ) with DoF

$$DoF = \frac{K + {\sum }_{k = 1}^{K} \frac{{I}_{k}}{{R}_{k}^{[ k ]} - {I}_{k}}}{1 + {\sum }_{k = 1}^{K} \frac{{I}_{k}}{{R}_{k}^{[ k ]} - {I}_{k}}} \qquad ( 3 )$$

and where Iₖ=max_{j≠k}Rₖ^{[j].}

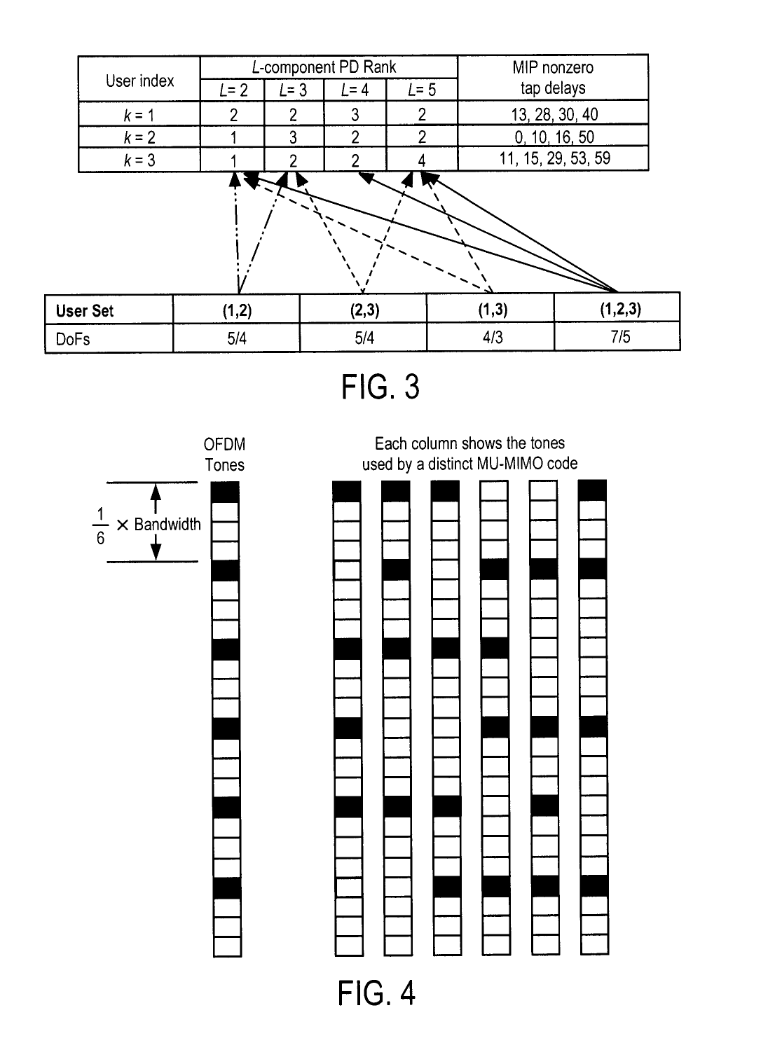

The table in FIG. 3 shows an illustrative example involving a four-antenna transmitter and three users. The MIP of each user channel has non-zero terms at the locations listed on the rightmost column in the figure table. Also shown are the ranks of each user's channel polyphase decomposition (PD) with L components for 2≦L≦5. MU-MIMO transmission for each user terminal-pair can be established by finding (L₁, L₂) pairs for which the conditions listed in Proposition 1 are satisfied. For the (1, 2) user terminal pair, one such code can be obtained with (L₁=2, L₂=3). According to Equation (3), this code yields DoF=5/4. Another code is based on the relatively prime pair (L₁=4, L₂=3), yielding DoF=6/5 (i.e., lower DoF). Similarly, for the (1, 3) user pair (and identifying user 3 as the second user in the pair) two codes are possible: one based on the set (L₁=2, L₂=5) (yielding DoF=4/3) and another based on the set (L₁=4, L₂=5) (yielding DoF=5/4). For the (3, 2) pair (identifying user 3 as the first user), there is only one code, that is, the code based on the set (L₁=5, L₂=3), yielding DoF=5/4. Finally, in this example, it also possible to operate 3-user codes serving the user triplet (1, 2, 3). One such code is based on (L₁=2, L₂=3, L₃=5), and yields, using Eqn. (3), DoF=7/5, while another is based on (L₁=4, L₂=3, L₃=5) and yields DoF=4/3.

MU-MIMO codes achieving the DoF associated with each such MU-MIMO transmission are detailed in a section below and involve MU-MIMO transmission schemes over a subset of tones from the set in Eqn. (2). FIG. 4 presents all the possible such subsets corresponding to the (1,2) user-pair with (L₁=2, L₂=3), and the tone set in Eqn. (2) corresponding to lₒ=0.

### Sample Embodiments

Embodiments of the invention include a class of scenarios for which channel variations over the OFDM plane can be exploited for efficient MU-MIMO transmission based on interference alignment. Embodiments of the invention present K user partial-IA MU-MIMO schemes and methods for identifying their use that allow exploiting opportunistic IA much more frequently.

In particular, the techniques puts forward the following:
A method for identifying scenarios where interference alignment (partial or perfect) can be exploited; the method exploits Proposition 1 to identify all such scenarios for any user tuple by checking the DoF provided by all viable {Lₖ} permutations.
Methods for selecting the best scenario for each user tuple; this is done by, e.g., selecting for each user tuple, the {Lₖ} combination that yields the highest performance. In one embodiment, this may involve the {Lₖ} combination that maximizes the DoF from Eqn. (3), or any other pertinent metric (such as, e.g., delivered sum or weighted sum rate).
Methods for scheduling users in K-user multi-user MIN/10 transmission based on information on the user MIPs; this can be done by first determining the highest-DoF code possible for each user-tuple; and then selecting user-tuples for scheduling subject to a system-wide fairness criterion.
Methods for assigning codes (that, e.g., achieve the associated DoF) to each scheduled user pair.

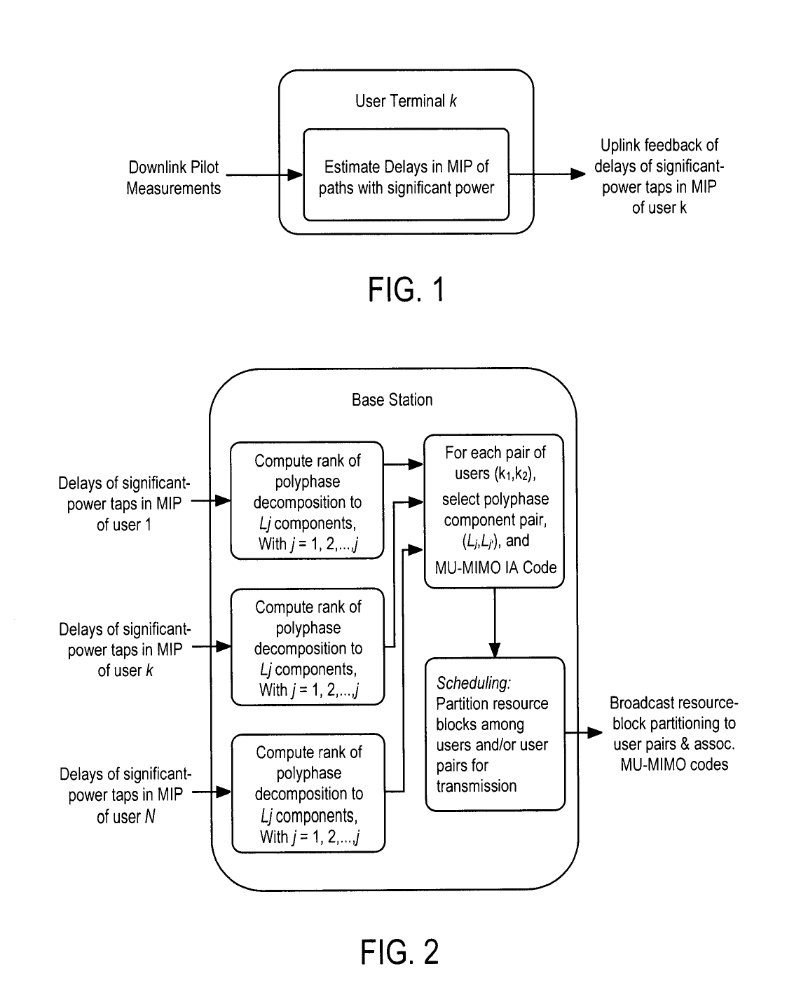

A typical operation at a user terminal is shown in block-diagram form in FIG. 1. Referring to FIG. 1, in one embodiment, user terminal k (for each k in a sufficiently large set) obtains downlink pilot measurements and, using these assessments, estimates (or tracks) its multipath intensity profile. The user terminal uses this estimate to signal back a subset of dominant-term locations and strengths of its MIP to the base-station. In one embodiment, the user estimates additional quantities. In one embodiment, this includes a set of parameters associated with each of many possible polyphase-decompositions (one for each L value). In particular, in one embodiment, a user signals the relative amount of power in the dominant R (out of L) polyphase components, for all values of R ranging from 1 to L−1. In one embodiment, these quantities are fed back (at, possibly, a slower rate than the rate they are estimated and, possibly, quantized) to the base station.

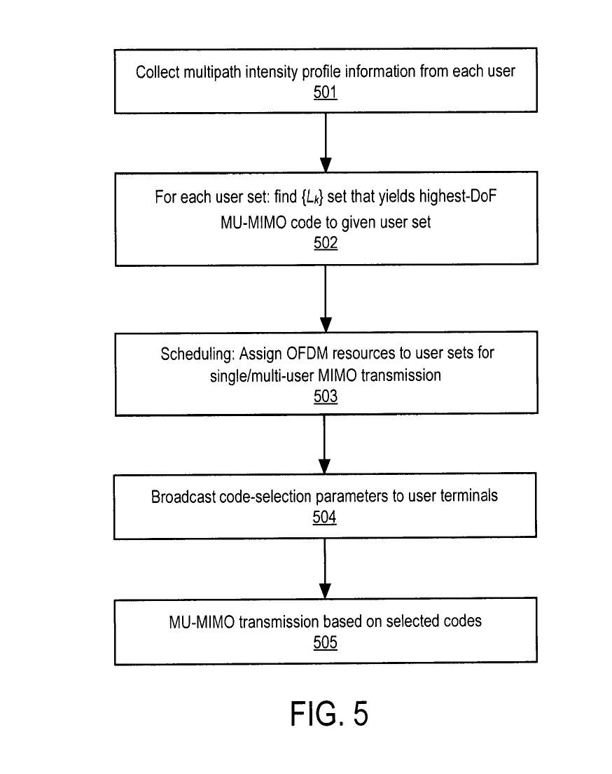

FIG. 2 is a data flow diagram of one embodiment of an operation at the base station showing the processing of pertinent CSI (from uplink feedback) from multiple user terminals, code selection for each user group (e.g., pair), and resource partitioning among user terminals and user terminal groups for single and multi-user transmissions. Referring to FIG. 2, based on feedback from a set of user terminals, the base-station selects a subset of users for (possible) MU-MIMO transmission. In one embodiment, for each user tuple considered for scheduling, the base-station chooses a multi-user MIMO transmission for the tuple. In one embodiment this is accomplished by selecting the polyphase decompositions tuple, {Lₖ}, which maximizes the DoF (e.g., using the DoF expression in Proposition 1), or some other relevant performance criterion (e.g., weighted user sum rate). In one embodiment, the base-station chooses groups of users for joint MU-MIMO transmission (using the MU-MIMO scheme chosen for each tuple). In one embodiment, at least one group of at least two users is scheduled for joint transmission over a subset of the OFDM plane. In one embodiment the Lₖ's associated with scheduled groups are relatively prime. In one embodiment, this user-tuple selection is based on a system-wide performance metric. In one such embodiment, the station assigns an activity fraction (fraction of usage of resources) to each user tuple, such that the average delivered DoF by the system are maximized, while making sure that each user gets a fair usage of resources. In particular, in one embodiment, all possible tuple combinations are initially considered, and the task is to assign an activity fraction to each user. In one embodiment, these fractions are then obtained by choosing the values that maximize a given utility function. In many unitily-function choices, solving for the optimal activity fractions is well known in the art. In one such embodiment, the utility function corresponds to the average DoF provided by the system across all its transmission resources. In this case, any convex optimizer can solve for the optimal activity fractions. In practice, simple suboptimal algorithms that are well-known in the art can also be exploited. One embodiment of the operation at the base station is also logically described by the flowchart in FIG. 5. The process is performed by processing logic that may comprise hardware (circuitry, dedicated logic, etc.), software (such as is run on a general purpose computer system or a dedicated machine), or a combination of both.

Referring to FIG. 5, the process begins by processing logic collecting MIP information from each user (processing block 501). Next, for each user group, processing logic finds the {Lₖ} set that yields the highest DoF MU-MIMO code to a given user group (processing block 502). Processing logic also assigns OFDM resources to user groups for single/multi-user MIMO transmissions (processing block 503) and broadcasts code-selection parameters to user terminals (processing block 504). Thereafter, processing logic performs MU-MIMO transmissions based on selected codes (processing block 505).

Note that in accordance to the code-designs in the following section, in one embodiment, the broadcasted parameters specifying the code enabling MU-MIMO transmission to a scheduled set of user terminals comprise: the {Lₖ} set and the {Iₖ} set in Prop. 1; the lₒ parameter in Eqn. (2); the vector pₒ used in the designs of the following section; and any other alternative specification that unambiguously specifies these parameters and thus uniquely defines the code used for transmission.

In one embodiment of the MU-MIMO schemes described herein, the number of OFDM tones in the system, F, is not factorizable in the form required by Proposition 1. However, F is large enough, so that it is possible to enable grouping together sets of channels in order to form matrices of the form H (lₒ) with the tones used being “close” in frequency to the ones in Eqn. (1) (i.e., spaced apart roughly by the same bandwidth as in Eqn. (1)).

Finally, it should be evident to the person skilled in the arts that many straightforward receiver embodiments are possible. One embodiment uses the receiver measurements on the alignment-block-2 (isolated-transmission) slots (tones) associated with each interfering symbol (symbol intended for another user) to zero-force interference from this symbol caused in all other slots (tones) it is transmitted, as is done with the zero-forcing receivers associated with MU-MIMO BIA (see, for example, Chenwei Wang, et al., “Aiming Perfectly in the Dark Blind Interference Alignment through Staggered Antenna Switching,” February 2010). When the interference-alignment dimensionality of that symbol is higher than 1 (multiple alignment-block-2 slots), then zero-forcing entails to adding a linear combination of the alignment-block-2 slots to cancel interference from any other tone this appears. This linear combination is in general different from one interfered toned to the next, but can be readily determined based on the OFDM index, and the code.

It should be evident to the person skilled in the arts that embodiments of this invention that consider power allocation extensions of the presented embodiments, analogous to those presented for BIA schemes in U.S. patent application Ser. No. 13/223,762, entitled “A Method to Deploy Efficient Blind Interference Alignment Using a Combination of Power Allocation and Transmission Architecture,” filed on Sep. 1, 2011, can be readily designed. In one embodiment, the “dominance” power-ratio indicators and rank indicators regarding the user intensity profile polyphase decompositions, together with possibly other parameters (such as e.g., large-scale SINR) are used to also choose a power allocation in the MU-MIMO code structure across different users, in order to improve the performance of one or more users at a (possibly small) cost in the performance of one or more of the other users. Also, direct and straightforward extensions of the MU-MIMO schemes presented herein can be developed for users with multiple receive antennas by exploiting the multiple active-antenna BIA code extensions of Wang, et al, “Aiming Perfectly in the Dark Blind Interference Alignment through Staggered Antenna Switching,” February 2010 presented in Chenwei Wang, et al., “Interference Alignment through Staggered Antenna Switching for MIMO BC with no CSIT,” Proc. Asilomar Conf, November 2010. It should be evident to the person skilled in the arts that embodiments of this invention that consider user terminals with N_{R}>1 receive antennas and with N_{T}=N_{f} N_{R} transmit antennas where with N_{f}≧2 can readily be generated with straightforward MIMO extensions of the single-receive antenna embodiments.

### Code Structure Over OFDM: Resource Allocation and Code Design

Embodiments of the code designs that can be used to enable MU-MIMO transmission achieving the DoF (multiplexing gains) listed in Proposition 1 are described. Specifically, given a set of relatively prime {Lₖ}'s and a set of {Rⱼ^{[k]}}'s satisfying Proposition 1, embodiments of code designs are described, which achieve the DoF in Eqn. (3) over a (properly chosen) subset of the tones in Eqn. (2).

Some of the elements of the BIA codes and their nomenclature from Wang, et al., “Aiming Perfectly in the Dark—Blind Interference Alignment through Staggered Antenna Switching,” February 2010 (hereinafter “Wang”) are described. A (K, M) BIA code from Wang is a code that simultaneously serves K user terminals each with a possible of M switchable single-antenna modes via a transmitter that has (at least) M transmit antennas. The (K, M) BIA code has length T=T₁+T₂ slots, with T₁=(M−1)^{K} and T₂=K(M−1)^{K-1}. It delivers to each of the K user terminals J M-dimensional vector symbols with J=(M−1)^{K-1}, and yields the maximum possible DoF of

$$DoFs ( M , K ) = \frac{JMK}{T} = \frac{MK}{M + K - 1}$$

A total of T₁ out of the total of T slots comprise “alignment block 1” (AB-1). In each AB-1 slot, the transmitter transmits a (possibly rescaled) sum of K M-dimensional information symbols, one such symbol per user terminal. The remaining T₂ (out of the total of T) slots are allocated to the “alignment block 2” (AB-2) (see Wang), and are used to transmit each M-dimensional user symbol on its own (once). As a result, each user symbol is transmitted in exactly M−1 “AB-1” slots (with other users' symbols) and once on its own in an AB-2 slot. The combinations of transmitted user symbols within the AB-1 slots can be chosen so that each user terminal can decode its own JM-dimensional symbols via an appropriate antenna-switching pattern over its M antenna-modes.

The set of M slots (M−1 of which are AB-1 and one is AB-2) over which a given symbol is transmitted are referred to as the alignment block for that symbol (Wang). Over that block of slots, the intended receiver cycles through its M antennas (thereby observing the symbol through a rank M matrix), and all other receivers hold their antenna-mode fixed, thereby aligning the resulting symbol interference in a one-dimensional space.

Next the extensions of the (K, M) BIA codes from (Wang) that enable achieving the DoF listed in Proposition 1 are described. First the focus is on the code design for the general K-user and then the two-user special case is considered.

The general code structure can be conveniently defined in terms of an alternative representation of the set of tones comprising the set in Eqn. (2). First note that a tone f=lₒ+mJ may also be identified, within the set F(lₒ) in (2) in terms of the variable m with 0≦m≦ΠⱼLⱼ−1, as well as any other variable related to m via a one-to-one transformation. In particular, consider the function p(m) defined as

p(m)=[p₁(m)p₂(m)Lp_{K}(m)] (4)

with pₖ(m)=rem(m, Lₖ), and where rem(a, b)=a−b└a/b┘, with └x┘ denoting the largest integer not exceeding x. Consider also the (K−1)-tuple p^{[k]}(m) arising by removing the k-th entry from the K-tuple p(m), i.e.,

p^{[k]}(m)=[p₁(m)Lpₖ₋₁(m)pₖ₊₁(m)Lp_{K}(m)]

In the case of Proposition 1, where {Lⱼ}ⱼ₌₁^{K} is a set of relatively prime numbers, the code structure can be alternatively identified by identifying each tone in the set F(lₒ) via the associated K-tuple of indices, p(m). This is because, in this case, the function m→p(m) in Eqn. (4) defines a one-to-one mapping between

$$S ( {\prod }_{j} {L}_{j} ) and {\prod }_{j} S ( {L}_{j} ) ,$$

and where we used S(N) to denote the set {0,1,2,L,N−1}, and

$${\prod }_{j} S ( {N}_{j} )$$

to denote the Cartesian product S(N₁)×S(N₂)×L×S(N_{K}).

This alternative p-vector based characterization turns out to be very convenient. Indeed, any given alignment block for user terminal k (Wang) (i.e., a set of tones over which a symbol for user terminal k is to be placed to enable IA) consists of Lₖ p vectors, all of which have the same p^{[k]} value. In particular, the set of all

$${\prod }_{j \neq k} {L}_{j}$$

alignment blocks for user terminal k are given by

$${A}^{[ k ]} = \{ {F}^{[ k ]} ( {p}^{[ k ]} ) {p}^{[ k ]} ∈ {\prod }_{j \neq k} S ( {L}_{j} ) \} \qquad$$

and where the alignment block associated with p^{[k]}=[p₁Lpₖ₋₁pₖ₊₁Lp_{K}] is given by

F^{[k]}(p^{[k]})={[a₁a₂La_{K}];{aⱼ=pⱼ,∀j≠k},aₖεS(Lₖ)}.

For notational convenience, we let x^{[k]}(p^{[k]}) denote the (potential) symbol for user terminal k defined on alignment block F^{[k]}(p^{[k]}).

Not all of the Lₖ tones in the alignment block need be used to transmit x^{[k]}(p^{[k]}). Furthermore, recall from Property 1 that the rank of the matrix channel of user k over F^{[k]}(p^{[k]}), as well as over any submatrix formed via a subset of Rₖ^{[k]} out of Lₖ consecutive tones in F^{[k]}(p^{[k]}), is Rₖ^{[k]}. As a result, to maximize the DoF, each symbol intended for user terminal k has to be Rₖ^{[k]} dimensional and must to be transmitted over a subset of Rₖ^{[k]} (out of the Lₖ) slots in the alignment block.

Note also that each symbol intended for user terminal k and transmitted over a set of such Rₖ^{[k]} slots (tones), is done so by a code whereby Iₖ=max_{j≠k}Rₖ^{[j]} of the slots are AB type-2 slots. This is so that each unintended receiver, i.e., receiver j for any j≠k, can cancel out the interference from this symbol in the remaining slots carrying that symbol. It is evident, that, in order to maximize the DoF, the code should use the remaining slots in AB-1 transmissions. It can then be readily shown that this approach would yield the DoF in Eqn. (3). In particular, subject to the constraint that Iₖ out of the Rₖ^{[k]} slots over which a symbol for user terminal k is transmitted are single-symbol (i.e., AB-2) transmissions (in order to enable IA at each of other users), the associated sum-DoF maximizing K-user “BIA” code has length T=T₁+T₂, with AB-1 length

T₁=Πₖ₌₁^{K}(Rₖ^{[k]}−Iₖ)

and AB-2 length

$${T}_{2} = {T}_{1} {\sum }_{k = 1}^{K} \frac{{I}_{k}}{{R}_{k}^{[ k ]} - {I}_{k}}$$

It transmits J^{[k]} Rₖ^{[k]}-dimensional symbols for user terminal k, with

J^{[k]}=T₁[Rₖ^{[k]}−Iₖ]⁻¹

and yields the DoF in Eqn. (3).

A code with these properties that achieves the DoF in Eqn. (3) can be readily defined. First, consider the alignment block corresponding to p^{[k]}=0 for any fixed but arbitrary user k, It consists of the channels of Lₖ tones with p values, such that p^{[k]}=0. Also, the pₖ entries of the p values associated with these tones are distinct and span the set {0, 1, . . . , Lₖ−1}. Let D^{[k]}(N) denote the N (out of Lₖ) distinct pₖ values of the N first tones (i.e., the N tones with the lowest m value) in the alignment block corresponding to p^{[k]}=0. Let also

x^{[k]}={p^{[k]}=[p₁Lpₖ₋₁pₖ₊₁Lpₖ];pⱼεD^{[j]}(Rⱼ^{[j]}−Iⱼ)∀j≠k}

and

Fₓ^{[k]}(p^{[k]})={[a₁La_{K}];{aⱼ=pⱼ,∀j≠k},aₖεD^{[k]}(Rₖ^{[k]})}

The code is defined as follows:

For each k e {1, 2, L, K}:
for each p^{[k]}εX^{[k]}:
   transmit a vector x^{[k]}(p^{[k]}) of dimension Rₖ^{[k]} over Fₓ^{[k]}(p^{[k]}).

It can be readily verified that |X^{[k]}| equals J^{[k]}. Thus, as required, the code sends J^{[k]} symbols to user terminal k, each of dimension Rₖ^{[k]}, and uses a total of T=T₁+T₂ slots with T₁ and T₂ defined above. It is straightforward to verify that user terminal k can cancel out all the interference from any given symbol intended for user terminal j for any j≠k. Indeed, by construction, there are Iⱼ≧Rⱼ^{[k]} AB-2 slots carrying any given such symbol for user terminal j, and these suffice for user terminal k to cancel out the symbol's contribution from the remaining Rⱼ^{[j]}−Iⱼ (AB-1) slots, over which this symbol is transmitted. Once all interference is removed, user terminal k can decode each of its own symbols, since it observes each such symbol through a rank-Rₖ^{[k]} channel (see Property 1).

In the special case involving K=2 user terminals, D^{[k]}(N)={rem(mL₂₋ₖ,Lₖ); 0≦m≦N−1}. The code comprises of the following symbols:
For each n₂εD^{[2]}(R₂^{[2]}−R₂^{[1]}, transmit the R₁^{[1]}-dimensional vector symbol x^{[1]}(n₂) over the set of tones {p=[n₁ n₂]; n₁εD^{[1]}(R₁^{[1])}.}
For each n₁εD^{[1]}(R₁^{[1]}−R₁^{[2]}), transmit the R₂^{[2]}-dimensional vector symbol x^{[2]}(n₁) over the tones {p=[n₁ n₂]; n₂ εD^{[2]}(R₂^{[2]})}.

Many other codes can also be constructed and used that satisfy the DoF of Proposition 1. For instance, one may start with the K alignment blocks containing an arbitrary tone/vector p=pₒ (different from the all-zero vector), and for each k use the associated p^{[k]} (corresponding the k-th user alignment block containing p=pₒ). Then one can define D^{[k]}(N) as the N pₖ entries associated with the set of N consecutive tones (with increasing m values and with wrap-around if the end is reached) starting with the tone corresponding to p=pₒ. Any such code achieves the DoF of Proposition 1.

### EXAMPLES

FIG. 3 is a three-user example, illustrating: a) the mapping of each user MIP nonzero tap delays to ranks in their L-component polyphase decompositions for a set of L values (top table); b) the corresponding pairings of users into polyphase components (arrow sets emanating from each entry in the bottom table); c) the DoF that can be achieved via the MU-MIMO IA codes in as described herein.

FIG. 4 is an example of resource block sets used by MU-MIMO implementations, which achieve the DoF in FIG. 3 for the user pair (1,2). Each of the 6 possible codes is designed by applying the code design algorithm in the code-design section and corresponds to using a different pₒ vector in its design.

### Embodiments of a Base Station and a User Terminal

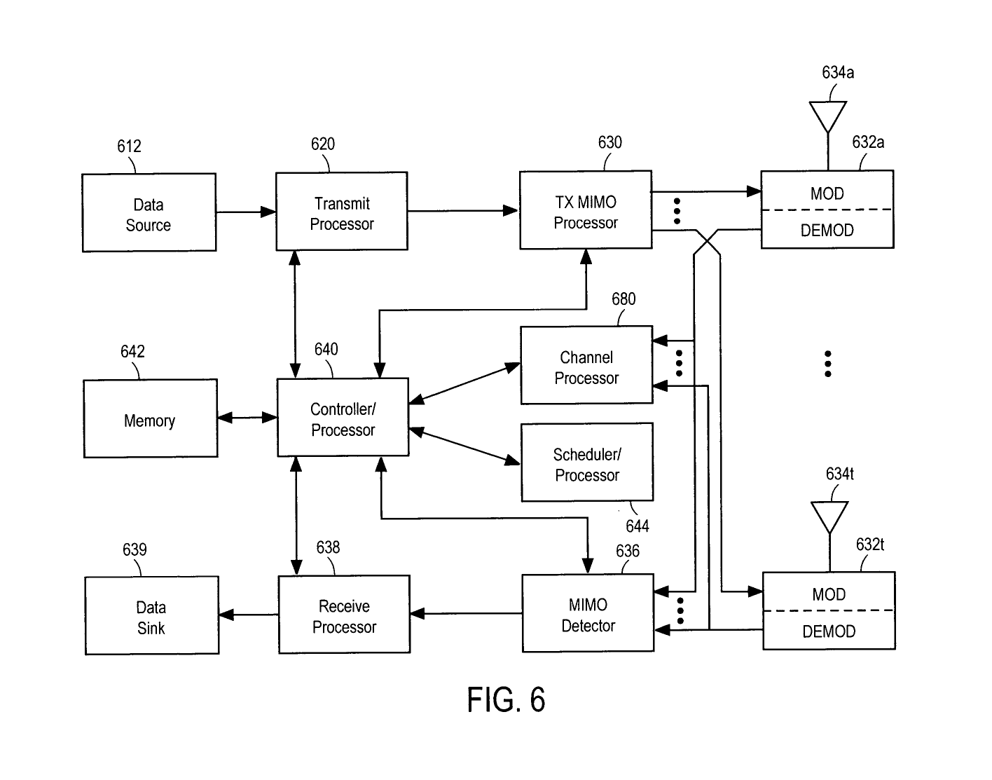

FIG. 6 shows a block diagram of a design of base station. Referring to FIG. 6, the base station is equipped with T (with T here denoting N_{T}) antennas 634a through 634t [In the FIG. 1 see 634r and 632r as opposed to 634t and 632t]. A transmit processor 620 receives data from a data source 612 for one or more user terminals, selects one or more modulation and coding schemes (MCS) for each user terminal, processes (e.g., encode and modulate) the data for each user terminal based on the MCS(s) selected for the user terminal, and provides data symbols for all user terminals. In one embodiment, transmit processor 620 also processes system information and control information and provides overhead symbols and control symbols. A transmit (TX) multiple-input multiple-output (MIMO) processor 630 performs spatial processing (e.g., precoding) on the data symbols, the control symbols, the overhead symbols, and/or the reference symbols, if applicable, and provides T output symbol streams to T modulators (MODs) 632a through 632t. Each modulator 632 processes a respective output symbol stream (e.g., for OFDM, etc.) to obtain an output sample stream. In one embodiment, each modulator 632 further processes (e.g., convert to analog, amplify, filter, and upconvert) the output sample stream to obtain a downlink signal. T downlink signals from modulators 632a through 632t are transmitted via T antennas 634a through 634t, respectively.

Scheduler 644 may schedule user terminals for data transmission on the downlink and/or uplink. As discussed above, scheduler 644 schedules user terminal groups (e.g., pairs) for MU-MIMO transmission, OFDM resources, and MU-MIMO transmission codes. Scheduler 644 schedules for transmission user terminal groups grouped based on their multipath intensity profiles, allocates OFDM resources to the user terminal groups for MIMO transmission, and assigns MU-MIMO transmission codes to the user terminal groups.

In one embodiment, the scheduler collects the multipath intensity profile information from a plurality of user terminals and groups of user terminals based on the delays (and possibly the receive power) of dominant paths in the multipath intensity profiles. In one embodiment, scheduler 644 groups user terminals by identifying a polyphase decomposition for a set of L values that yields a highest degree-of-freedom MU-MIMO code for a given user terminal set. In one embodiment, scheduler 644 allocates an activity fraction to each user terminal group.

Channel processor 680 performs channel processing operations associated with UL transmission. In the DL, channel processor 680 may be used to perform a variety of operations. In one embodiment, channel processor 680 processes the dominant delays (and possibly powers) in the user MIP fed back by a user, and generates the polyphase ranks associated with each user's channel as shown in FIG. 2. In one embodiment, these three boxes are performed in the scheduler 644 as described above.

At the base station, the uplink signals from user terminals are received by antennas 634, processed by demodulators 632, detected by a MIMO detector 636 if applicable, and further processed by a receive processor 638 to obtain decoded data and control information sent by the user terminal. Processor 638 provides the decoded data to a data sink 639 and the decoded control information to controller/processor 640.

Controller/processor 640 directs the operation at the base station. Processor 640 and/or other processors and modules at the base station perform or direct operations and/or other processes for the techniques described herein. Memory 642 stores data and program codes for the base station.

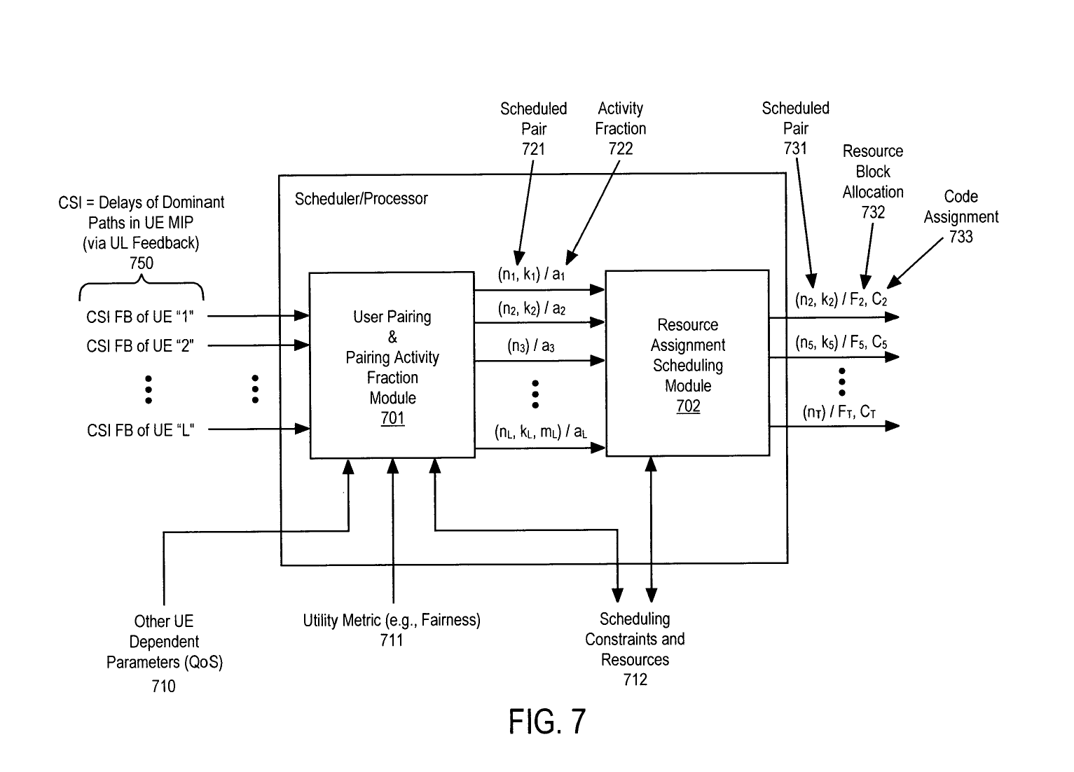

FIG. 7 is a block diagram of one embodiment of a scheduler. Referring to FIG. 7, the scheduler comprises a user pairing & pairing activity fraction module 701 that receives CSI information 750 that includes the delays of dominant paths in the MIPs of user terminals. In one embodiment, this is received via uplink feedback. Module 701 may also receive other user terminal dependent parameters 710 (e.g., QOS), a utility metric 711 (e.g., proportional/maxmin fairness based), and/or information indicative of scheduling constraints 712 (allowable delays in user data delivery, size of user data buffers, etc). In response to these inputs, module 701 uses the techniques described above to generate multiple sets of scheduled pairs 721 and activity fractions 722, one for each of scheduled pairs 721. Resource assignment scheduling module 702 receives scheduled pairs 721 and activity fractions 722 as well as information 712 indicating resources and constraints. In response to these inputs, module 702 generates, in a manner described above, scheduled pairs 731 with a resource block allocation 731 and code assignment 732 for each of the scheduled pairs 731.

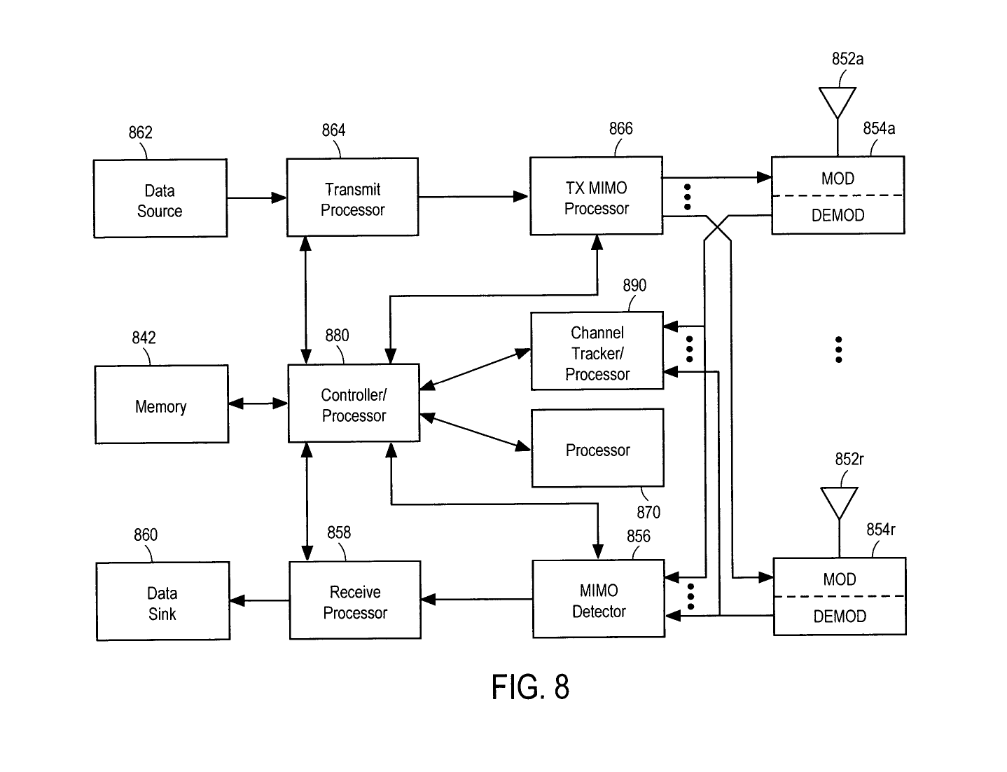

FIG. 8 is a block diagram of one embodiment of a user terminal. Referring to FIG. 8, antennas 852a through 852r receives downlink signals from a base station and may provide received signals to demodulators (DEMODs) 854a through 854r, respectively. In one embodiment, each demodulator 854 conditions (e.g., filter, amplify, downconvert, and digitize) its received signal to obtain input samples. In one embodiment, each demodulator 854 further processes the input samples (e.g., for OFDM, etc.) to obtain received symbols. A MIMO detector 856 obtains received symbols from all R demodulators 854a through 854r, performs MIMO detection on the received symbols if applicable, and provides detected symbols. A receive processor 858 processes (e.g., demodulate and decode) the detected symbols based on based on a code assignment made by a base station to a user terminal group of which the user terminal is a part, where the code assignment is made based on the multipath intensity profile (delays of dominant paths in the MIPs of user terminals), provides decoded data for the user terminal to a data sink 860, and provides decoded control information and system information to a controller/processor 880.

On the uplink, at the user terminal, transmit processor 864 receives and processes data from a data source 862 and control information from a controller/processor of a base station (e.g., controller/processor 680 of FIG. 6). In one embodiment, processor 864 also generates reference symbols for one or more reference signals. The symbols from transmit processor 864 are precoded by a TX MIMO processor 866, further processed by modulators 854a through 854r (e.g., for SC-FDM, OFDM, etc.), and transmitted to a base station.

The user terminal also includes a channel tracker/processor 890 to track the delays of dominant paths in its multipath intensity profile. In one embodiment, this is accomplished by first using the observations over pilot transmission over a large block (e.g., many 100's) of OFDM symbols to estimate the tap delays and their powers, This can be done by the use of a number of approaches including traditional parametric models or newer compressed sensing approaches. These can then be slowly updated over time as new pilot observations are available. These tap-delay power estimates then are fed back to the base station via transmit processor 864, TX MIMO processor 866, modulators 854a through 854r, and antennas 852a through 852r.

In one embodiment, processor 870, tracks MIP changes and schedules MIP feedback, by effecting feedback on the uplink channel, such as requesting feedback at the base station. In one embodiment, processor 870 performs other important functions such as the following:

Based on parsing the DL control information controller 880 extracts the portion specifying the MU-MIMO code and provides it to processor 870, which in turn, uses this information to map the OFDM observations in alignment blocks, process the alignment blocks to eliminate interference from the other user streams, and recombines the resulting interference-suppressed measurements into groups, with each group corresponding to a transmitted data vector intended for the user. These groups of “MIMO” measurements are then passed to receive processor 858 for decoding. At this stage, processor 858 can perform SU-MIMO coherent decoding on the effective channel. Note for coherent decoding, there is also a need for the CSIR/channel estimation based on the DL pilots at the time of MU-MIMO transmission. This function can alternatively be performed by processor 870.

Controller/processor 880 directs the operation at the user terminal. Memory 842 stores data and program codes for the base station.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
grouping user terminals into groups based on their multipath intensity profiles, where at least one of the groups has two or more user terminals;
scheduling user terminal groups for MU-MIMO transmission;
allocating OFDM resources to the user terminal groups for MIMO transmission;
assigning MU-MIMO transmission codes to the user terminal groups; and
performing MU-MIMO transmission of the user terminal groups using assigned MU-MIMO transmission codes.

2. The method defined in claim 1 further comprising:
collecting multipath intensity profile information from a plurality of user terminals.

3. The method defined in claim 1 wherein grouping user terminals is based on delays of dominant paths in the multipath intensity profiles.

4. The method defined in claim 1 wherein grouping user terminals comprises:
identifying a subset of distinct operated L-component polyphase decompositions of information in the multipath intensity profile, that yields the highest degree-of-freedom (DoF) MU-MIMO code for a given user terminal set, each L-component polyphase decomposition associated with a distinct value of L, L being an integer greater than 1.

5. The method defined in claim 1 wherein at least one MU-MIMO code assigned to a user terminal group is for a set of K user terminals and is based on at least K distinct polyphase decompositions of the multipath intensity profile of each user terminal in the group, where the number of polyphase components of each of the distinct polyphase decompositions is different from other of the polyphase decompositions, K being an integer.

6. The method defined in claim 5 further comprising determining a user rank for each user terminal and for each polyphase decomposition.

7. The method defined in claim 6 further comprising determining user-rank sets for each user terminal group of size K, where K is greater than one, with one user-rank set for each of the at least K polyphase decompositions, and identifying a maximum DoF achievable for any K of the size-K rank sets.

8. The method defined in claim 6 wherein assigning MU-MIMO transmission codes to the user terminal groups comprises assigning MU-MIMO transmission codes to the K-user terminal groups, and further comprising, for each user rank set, selecting a code that achieves the maximum DoF for the set of K polyphase decompositions among all possible choices for the user group of size K.

9. The method defined in claim 1 further comprising broadcasting code-selection parameters to user terminals.

10. The method defined in claim 1 further comprising allocating an activity fraction to each user terminal group.

11. The method defined in claim 1 wherein each user terminal group comprises a pair of user terminals.

12. A base station comprising:
a plurality of antennas;
a plurality of modulation units coupled to the plurality of antennas to perform modulation for signals being transmitted by the plurality of antennas;
a transmit MIMO processor coupled to the plurality of modulation units to generate signals for transmission;
a scheduler operable to schedule for transmission user terminal groups grouped based on their multipath intensity profiles, allocate OFDM resources to the user terminal groups for MIMO transmission, and assign MU-MIMO transmission codes to the user terminal groups, wherein at least one of the user terminal groups includes two or more user terminals; and
a controller coupled to the scheduler and the transmit MIMO processor to cause the transmit MIMO processor, the plurality of modulation units and the plurality of antennas to perform MU-MIMO transmission of the user terminal groups using allocated OFDM resources and assigned MU-MIMO transmission codes.

13. The base station defined in claim 12 further comprising:
a plurality of demodulation units coupled to the plurality of antennas to perform demodulation for signals being received by the plurality of antennas;
a MIMO detector coupled to receive signals from the plurality of demodulation units;
a receive processor coupled to the MIMO detector to process signals from the MIMO detector.

14. The base station defined in claim 13 wherein the scheduler collects the multipath intensity profile information from a plurality of user terminals via the plurality of demodulation units, the MIMO detector and the receive processor.

15. The base station defined in claim 12 wherein the scheduler groups user terminals based on delays of dominant paths in the multipath intensity profiles.

16. The base station defined in claim 12 wherein the scheduler groups user terminals by identifying a subset of distinct operated L-component polyphase decompositions of information in the multipath intensity profile, that yields the highest degree-of-freedom (DoF) MU-MIMO code for a given user terminal set, each L-component polyphase decomposition associated with a distinct value of L, L being an integer greater than 1.

17. The base station defined in claim 12 wherein the scheduler assigns at least one MU-MIMO code to a user terminal group is for a set of K user terminals based on at least K distinct polyphase decompositions of the multipath intensity profile of each user terminal in the group, where the number of polyphase components of each of the distinct polyphase decompositions is different from those of other polyphase decompositions, K being an integer.

18. The base station defined in claim 17 wherein the scheduler is operable to determine a user rank for each user terminal and for each polyphase decomposition.

19. The base station defined in claim 18 wherein the scheduler is operable to determine user-rank sets for each user terminal group of size K, with one user-rank set for each of the at least K polyphase decompositions, where K is greater than one, and identifies a maximum DoF achievable for any K of the size-K rank sets.

20. The base station defined in claim 18 wherein the scheduler is operable to assign MU-MIMO transmission codes to the user terminal groups including assigning MU-MIMO transmission codes to the K-user terminal groups, and, for each user rank set, selects a code that achieves the maximum DoF for the set of K polyphase decompositions among all possible choices for the user group of size K.

21. The base station defined in claim 12 wherein the scheduler, for each group of K user terminals, K being an integer >1, selects K distinct values for L, where L denotes the number of components in the polyphase decomposition the user multipath intensity profiles, and a MU-MIMO code based on ranks of the associated K polyphase decompositions for each of the K users in the group, each of the K ranks for each user terminal being computed based on delays of significant power taps in the multipath intensity profile of the user terminal and the polyphase decomposition to L components for the associated L value.

22. The base station defined in claim 12 wherein the plurality of antennas broadcasts code-selection parameters to user terminals.

23. The base station defined in claim 12 wherein the scheduler is operable to allocate an activity fraction to each user terminal group.

24. The base station defined in claim 12 wherein each user terminal group comprises a pair of user terminals.

25. The base station defined in claim 12 wherein the scheduler groups user terminals in response to one or more of a group consisting of: a utility metric, quality of service (QOS) information, at least one other user terminal parameter.

26. A user terminal comprising:
one or more antennas;
a plurality of modulation units coupled to the one or more antennas to perform modulation for signals being transmitted by the one or more antennas;
a transmit MIMO processor coupled to the plurality of modulation units to generate signals for transmission;
a channel tracker coupled to track delays of dominant paths in a multipath intensity profile associated with the user terminal and cause the delays to be feedback via the transmit MIMO processor, the plurality of modulation units and the one or more antennas;
a plurality of demodulation units coupled to the one or more antennas to perform demodulation for signals being received by the one or more antennas;
a MIMO detector coupled to receive signals from the plurality of demodulation units; and
a receive processor coupled to the MIMO detector to process signals from the MIMO detector, wherein the receive processor applies appropriate decoding based on a code assignment made by a base station to a user terminal group of which the user terminal is a part, the code assignment made based on the multipath intensity profile.

27. The user terminal defined in claim 24 wherein the channel tracker causes the dominant path delays to be fed back to the base station using an uplink lower-rate feedback channel.
